(19) United States
(12) Patent Application Publication
(10) Pub. No.: US 2008/0101586 A1
(43) Pub. Date: May 1, 2008

(54) Server apparatus

(75) Inventors: Shigeru Fukazawa, Hachioji-shi (JP); Yasumasa Sasaki, Tachikawa-shi (JP); Fumikazu Matsukawa, Ome-shi (JP); Koji Shima, Sagamihara-shi (JP); Nobuyuki Takeda, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,406

(22) Filed: Oct. 24, 2007

(30) Foreign Application Priority Data
Oct. 31, 2006 (JP) 2006-297143

(51) Int. Cl. H04M 7/00

(52) U.S. Cl. 379/229

(57) ABSTRACT

According to one embodiment, a server apparatus includes a memory which stores a second management table which associates telephone IDs of external telephone terminals to be connected to the external communication network with user IDs of external data terminals to be connected to the external communication network, and a controller which refers to the first and the second management tables, and executes communication connections among the data terminals to be associated with the telephone IDs of the telephone terminals and the external data terminals to be associated with the telephone IDs of the external telephone terminals based on a reference results of the first and the second management tables, when the call connections are established among the telephone terminals and the external telephone terminals in accordance with connection requests generated from the telephone terminals.

### CROSS-REFERENCE TO RELATED APPLICATIONS

This application is based upon and claims the benefit of priority from Japanese Patent Application No. 2006-297143, filed Oct. 31, 2006, the entire contents of which are incorporated herein by reference.

### BACKGROUND

1. Field

One embodiment of the present invention relates to an improvement in a server apparatus of a visual communication system, for example, capable of dealing a video signal, computer data, etc., in addition to a voice signal by connecting the server apparatus to a telephone exchange apparatus via a communication channel.

2. Description of the Related Art

A local area networks (LANs) have been used in offices and business establishments. In each of this LANs, for example, a telephone exchange apparatus such as a private branch exchange (PBX) and a key telephone apparatus accommodates telephone sets as extension terminals, and the telephone exchange apparatus makes exchange connections among the extension terminals and an external communication network such as a public network, and between extension terminals to enable communications.

Recently, a system in which a server with a data terminal such as a video telephone terminal and a personal computer connected thereto is connected to the telephone exchange apparatus via a transmission channel to make a voice communication system using the telephone exchange apparatus cooperate with a data communication system using a server has been disclosed (e.g., Jpn. Pat. Appln. KOKAI Publication No. 2005-33662).

Meanwhile, as for such a system given above, which has a parallel type structure of the telephone exchange apparatus and the server, a visual communication system which makes inter-terminal communications connected onto the identical LAN by cooperating with extensions has been disclosed.

However, in the present circumstances, a visual communication system which passes through an external communication network such as the public network and the Internet has been in an examination stage and has not been actualized yet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred schematic configuration view depicting a visual communication system regarding a first embodiment of the invention;

FIG. 2 is a preferred view depicting an example of an internal user table stored in a database depicted in FIG. 1;

FIG. 3 is a preferred view depicting an example of an external user table stored in the data base depicted in FIG. 1;

FIG. 4 is a preferred view depicting an example of an internal user list display stored in the database depicted in FIG. 1;

FIG. 5 is a preferred block diagram depicting a functional configuration of an internal server depicted in FIG. 1;

FIG. 6 is a preferred sequence view depicting operations to establish sessions between an internal data terminal and an external data terminal in the first embodiment of the invention;

FIG. 7 is a preferred view depicting a screen example to confirm a registered telephone number in the first embodiment of the invention;

FIG. 8 is a preferred sequence view to confirm the registered telephone number in the first embodiment of the invention;

FIG. 9 is a preferred view depicting an example of an external user list display to be stored and managed in and by the database as a second embodiment of the invention; and

FIG. 10 is a preferred sequence view depicting operations to establish sessions between an internal data terminal and an external data terminal in the second embodiment of the invention.

### DETAILED DESCRIPTION

Various embodiments according to the invention will be described hereinafter with reference to the accompanying drawings. In general, according to one embodiment of the invention, a server apparatus which receives a call information event including telephone IDs specifying a plurality of telephone terminals to be made call connections from a telephone exchange apparatus configured to execute exchange processing among the plurality of the telephone terminals and to connect an external communication network, and makes communication connections among a plurality of data terminals cooperate with the call connections based on a first management table with user IDs to be each assigned to the plurality of data terminals in association with the telephone IDs of the plurality of telephone terminals stored therein, comprising: a memory which stores a second management table which associates telephone IDs of external telephone terminals to be connected to the external communication network with user IDs of external data terminals to be connected to the external communication network; and a controller which refers to the first and the second management tables, and executes communication connections among the data terminals to be associated with the telephone IDs of the telephone terminals and the external data terminals to be associated with the telephone IDs of the external telephone terminals based on a reference results of the first and the second management tables, when the call connections are established among the telephone terminals and the external telephone terminals in accordance with connection requests generated from the telephone terminals.

### First Embodiment

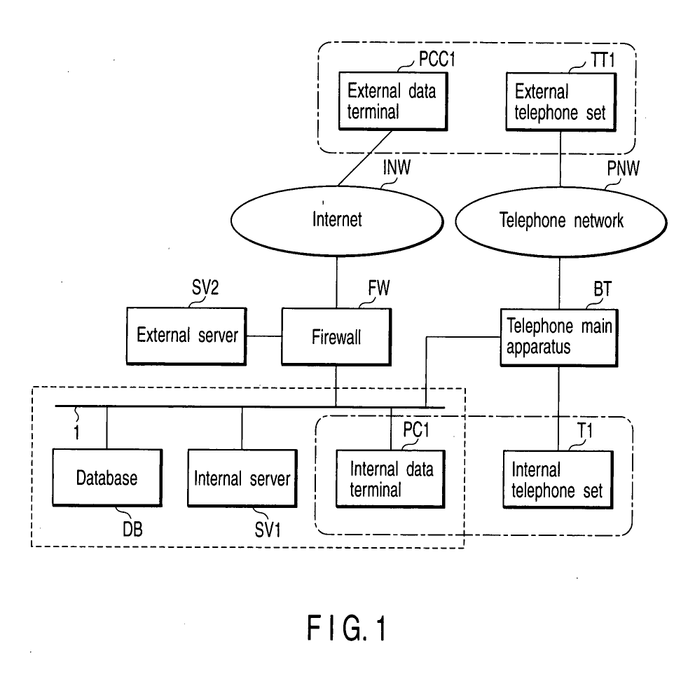

FIG. 1 is a schematic configuration view illustrating a visual communication system regarding the first embodiment of the invention.

Such a system, as shown in FIG. 1, includes a telephone main apparatus BT, an internal server SV1, and a database DB, and the main apparatus BT, the internal server SV1 and the database DB are connected with one another via a LAN 1.

The main apparatus BT accommodates a plurality of extension telephone sets (FIG. 1 shows only an extension telephone set T1) via extension lines. The main apparatus BT is also connected to a telephone network PNW. The main apparatus BT executes exchange processing among extensions, or between the telephone set T1 and the network PNW. An external telephone set TT1 is connected to the telephone network PNW.

The internal server SV1 accommodates a plurality of internal data terminals (FIG. 1 shows only an internal data terminal PC1) via the LAN 1. The data terminal PC1 is formed of a general-purpose personal computer and operates in relation to the telephone set T1. The internal server SV1 executes an additional function for the main apparatus BT and, for example, processes media information such as video. Further, the internal server SV1 is connected to an external server SV2 through a fire wall FW and also connected to the Internet INW. An external data terminal PCC1 is connected to the Internet INW.

An internal user table, an external user table, and an internal user list are stored in the database DB.

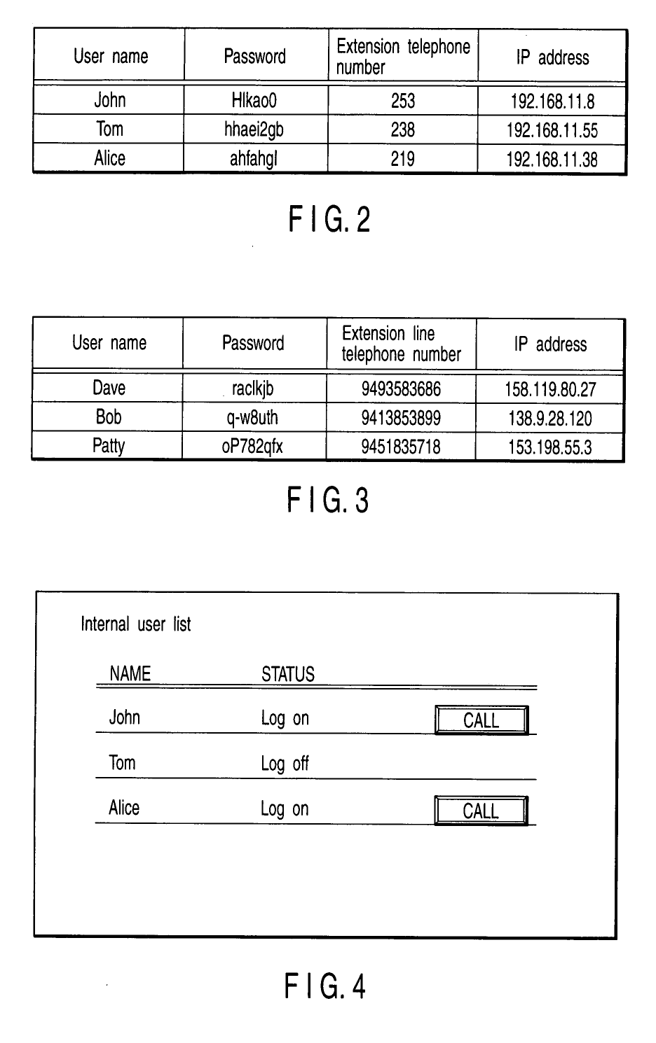

The internal user table is, as shown in FIG. 2, a table storing information about internal users to be notified when the internal users log on the visual communication system. The internal user table consists of internal user's names, passwords, extension telephone numbers, and IP addresses of the internal data terminals.

The external user table is, as shown in FIG. 3, a table storing information about external users notified when the external users log on the visual communication system. The external user table consists of external user's names, passwords, subscriber telephone numbers, and IP addresses of the external data terminals.

The internal user list displays, as shown in FIG. 4, the internal user's names and log-on statuses, and has call keys (CALLs) to start telephone speeches to and from logged on users.

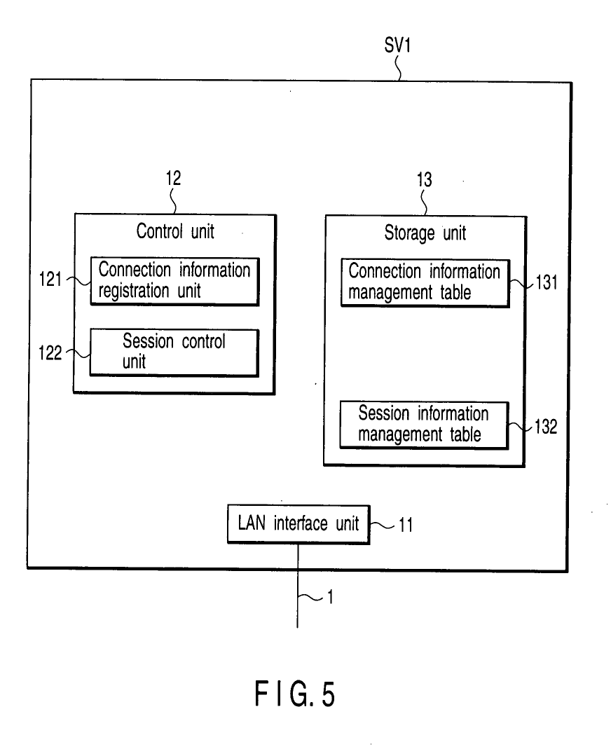

FIG. 5 is a block diagram illustrating a functional configuration of the aforementioned internal server SV1.

The internal server SV1 includes a LAN interface unit 11, a control unit 12, and a storage unit 13. Among of them, the LAN interface unit 11 performs interface processing to and from the LAN 1.

The storage unit 13 stores routing information etc., necessary for connection control of the control unit 12. Further, the storage unit 13 is provided with a connection information management table 131 (hereinafter referred to as management table 131), and a session information management table 132 (hereinafter referred to management table 132).

Data showing correspondence relations among telephone numbers (telephone IDs) of the extension telephone set T1 or the external telephone set TT1 and status information showing a connection status is stored in the management table 131.

Information showing the session status of the internal data terminal PC1 and the external data terminal PCC1 is stored in the management table 132.

The control unit 12 includes a connection information registration unit 121 (hereinafter referred to as registration unit 121), and a session control unit 122 as a new function regarding the invention in addition to a control function regarding the status management of the terminal PC1 and a cooperating operation between the terminal PC1 and the telephone set T1.

The registration unit 121 determines that, for example, the telephone set T1 and the telephone set TT1 are brought into a speech with each other by analyzing a call information event notified from the main apparatus BT to register the connection information in the management table 131.

Control unit 122 reads out that the telephone set T1 is associated with the terminal PC1 and that the telephone set TT1 is associated with the terminal PCC1 from the data base DB, and retrieves the session status between the terminal PC1 and the terminal PCC1 from the management table 132. For example, if the visual communication system starts speeches from now, since the terminal PC1 and the terminal PCC1 have not started session with each other, the control unit 122 controls the visual communication system so as to start the session between the terminals PC1 and PCC1.

Next, operations of the visual communication system configured as mentioned above will be described.

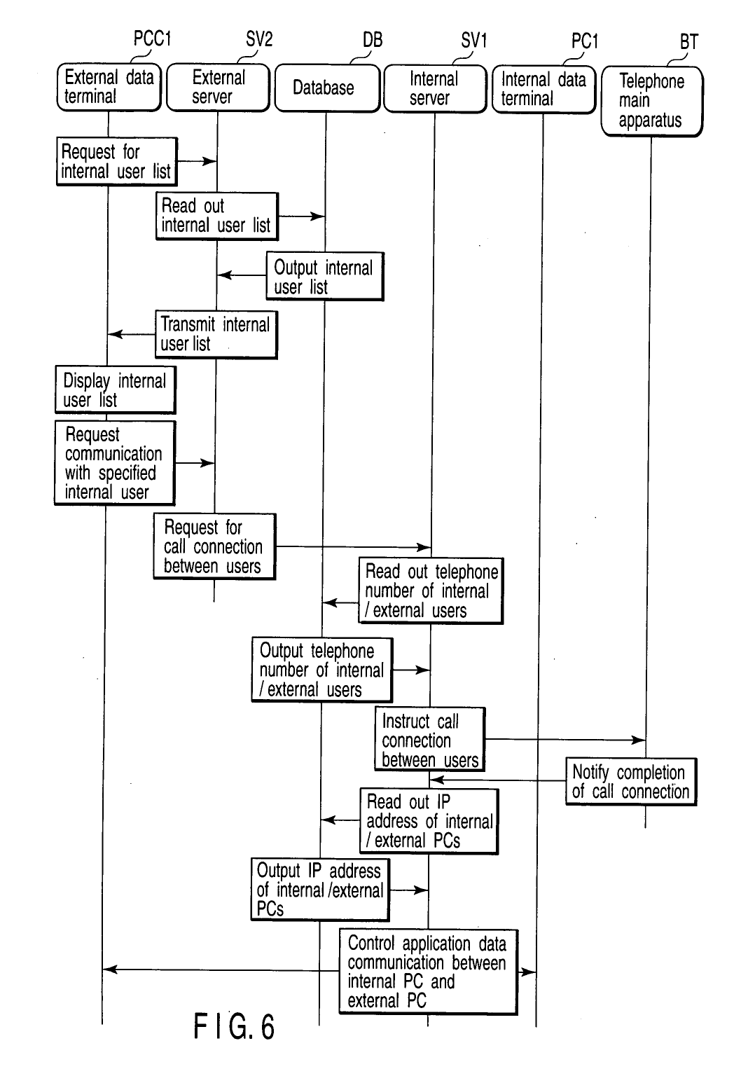

FIG. 6 is a sequence view illustrating operations to establish the session between the internal data terminal PC1 and the external data terminal PCC1.

The external user firstly requests for an internal user list display to the external server SV2 by means of the terminal PCC1. The external server SV2 reads out the internal user list from the database DB. The external server SV2 processes the user list output from the database DB into a form shown in FIG. 4 to transmit it to the terminal PCC1.

The terminal PCC1 then displays the user list on a screen. Therefore, the external user can come to know the internal user through this display in a list.

In this situation, it is assumed that the external user depresses a call key associated to a specified internal user by means of the terminal PCC1. The terminal PCC1 then requests for a speech with the specified internal user to the external server SV2. The server SV2 notifies the external user's name and the specified internal user's name to the internal server SV1 to require a call connection.

The server SV1 reads out the extension telephone number of the internal user and the subscriber telephone number to instruct the call connection between the internal and external users to the telephone main apparatus BT.

When an event of a call connection completion is notified from the main apparatus BT, the internal server SV1 reads out the IP addresses of the data terminals PC1 and PCC1 from the database DB to control so as to make an application data communication between the data terminals PC1 and PCC1.

As described above, in the first embodiment, the visual communication system stores and manages the external user table, which associates the external line telephone number of the external telephone terminal TT1 connected to the telephone network PNW and the IP address of the external data terminal PCC1 connected to the Internet INW, into the database DB, and when the external user desires a visual communication with the internal user, the system acquires the internal user list stored and managed in and by the database DB by using the external data terminal PCC1. The visual communication system uses the internal user list to make the internal telephone set T1 of the internal user call to the external telephone set TT1 owned by the external user by using the internal user list, and when the call connection between the internal telephone set T1 and the external telephone set TT1 is established, the internal server SV1 establishes the session between the internal data terminal PC1 associated with the internal telephone set T1 and the external data terminal PCC1 associated with the external telephone set TT1 by referring to the internal user table and the external user table stored and managed in and by the data base DB.

Accordingly, the system is not limited to be usable for the extension telephone, but the system may make the call connection between the subscriber telephone and the extension telephone cooperate with the application data communication. Therefore, even the external user, it may make a visual conference etc., with the internal user, thereby, the convenience of the user is extremely improved.

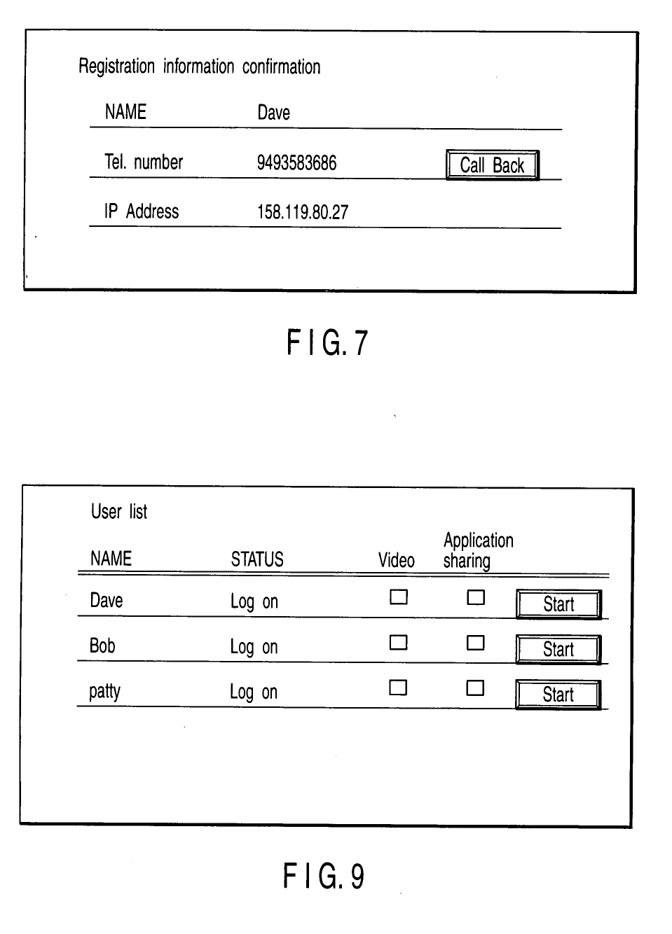

FIG. 7 illustrates a screen example to confirm the registered telephone number in the foregoing first embodiment. The visual communication system in the first embodiment has a ‘Call Back’ key to confirm whether the telephone number that is the registration information is correct.

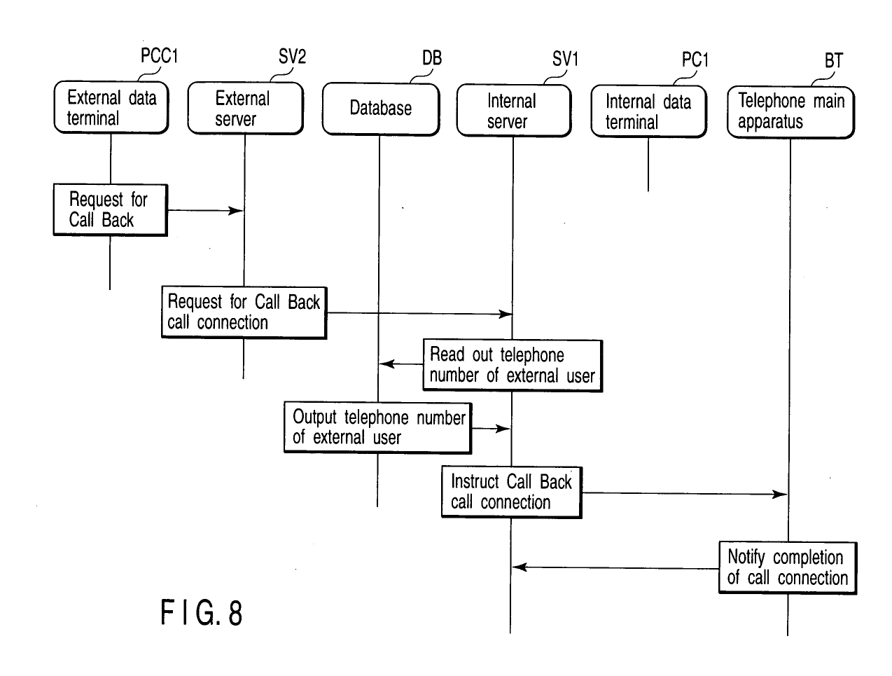

FIG. 8 shows a control sequence to confirm the registered telephone number. The external user requests for ‘Call Back’ to the external server SV2 by depressing the ‘Call Back’ key at the external data terminal PCC1. The external server SV2 requests for the ‘Call Back’ connection to the internal server SV1, reads out the telephone number from the database DB to make the ‘Call Back’, and instructs the ‘Call Back’ to the main apparatus BT.

Therefore, the external user may confirm whether or not its own external telephone number and the IP address are correctly registered in the external user table stored and managed in and by the database DB.

### Second Embodiment

FIG. 9 illustrates an example of the external user list display to be stored and managed in and by the data base DB as the second embodiment of the invention. The external user list display displays external user's names and log-on statuses, and includes a means for selecting applications to start together with logged on external users and start keys to start application data communications.

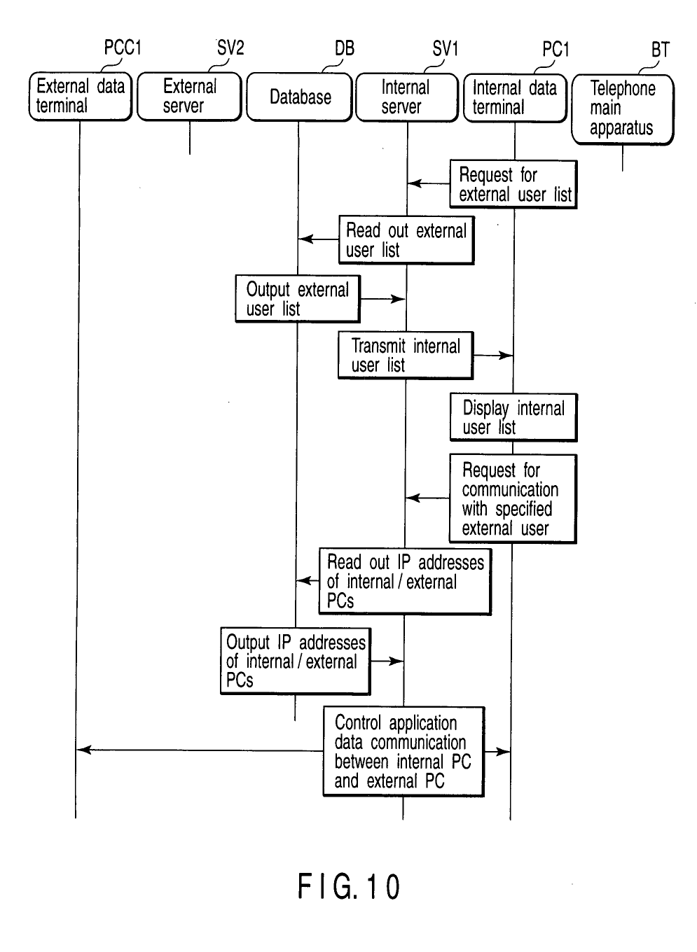

FIG. 10 is a sequence view illustrating operations of establishment of the session between the internal data terminal PC1 and the external data terminal PCC1.

Now, it is assumed that, for instance, the internal telephone set T1 is in a speech with the external telephone set TT1.

In such a status, it is assumed that the internal user operates to require the external user list display from the internal data terminal PC1 to the internal server SV1. The internal server SV1 then processes the external user list which is output from the database DB in the form shown in FIG. 9 to transmit it to the internal data terminal PC1.

The terminal PC1 then displays the external user list onto a screen. In this situation, the internal user depresses the start key at the terminal PC1 to notify the application to be started together with the specified external user to the internal server SV1. The internal server SV1 reads out the IP addresses of the data terminals PC1 and PCC1 from the database DB to control so as to make an application data communication between the data terminals PC1 and PCC1.

As mentioned above, in the foregoing second embodiment, in the status in which the internal telephone set T1 and the external telephone set TT1 are call-connected with each other, the visual communication system may cooperate the session establishment between the internal data terminal PC1 to be associated with the internal telephone set T1 and the external data terminal PCC1 to be associated with the external telephone set TT1 with the call connection through a simple procedure by using the external user list stored and managed in and by the database DB in accordance with the instruction input from the internal data terminal PC1.

According to the aforementioned second embodiment, the visual communication system may start a communication in a manner that users being in a speech by means of the subscriber's telephone and the extension telephone select a desired application data communication.

### Other Embodiment

The invention is not limited to each of the foregoing embodiments. For example, although in each of the embodiments, two servers of the internal server and the external server share the respective processing, but one server may process both the processing.

Further, a configuration and a type of a server, a type of a telephone exchange apparatus (not limited to telephone main apparatus, but a PBX is usable), a type of a telephone terminal, a type of a data terminal, stored content of each table, a session control method between data terminals, etc., may be embodied in a various modifications without departing from the concept of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives a call information event including telephone IDs specifying a plurality of telephone terminals to be made call connections from a telephone exchange apparatus configured to execute exchange processing among the plurality of the telephone terminals and to connect an external communication network, and makes communication connections among a plurality of data terminals cooperate with the call connections based on a first management table with user IDs to be each assigned to the plurality of data terminals in association with the telephone IDs of the plurality of telephone terminals stored therein, comprising:
a memory which stores a second management table which associates telephone IDs of external telephone terminals to be connected to the external communication network with user IDs of external data terminals to be connected to the external communication network; and
a controller which refers to the first and the second management tables, and executes communication connections among the data terminals to be associated with the telephone IDs of the telephone terminals and the external data terminals to be associated with the telephone IDs of the external telephone terminals based on a reference results of the first and the second management tables, when the call connections are established among the telephone terminals and the external telephone terminals in accordance with connection requests generated from the telephone terminals.

2. The server apparatus according to claim 1, wherein
the controller comprises:
an outgoing unit which notifies the first management table to a user in accordance with an instruction input by a user of an external data terminal stored in the second management table, and when the user inputs a selection instruction for a communication partner stored in the first management table, executes outgoing processing from a telephone terminal corresponding to the selected telephone ID to an external telephone terminal to be associated with the external data terminal; and
a connector which refers to the first and the second management tables, when a response operation is performed by the external telephone terminal in response to the outgoing, and executes communication connections among data terminals to be associated with the telephone IDs of the telephone terminals and external data terminals to be associated with the telephone IDs of the external telephone terminals based on a reference results of the first and the second management tables.

3. The server apparatus according to claim 1, wherein
the controller comprises a registration confirmation unit which notifies the second management table to a user of an external data terminal in accordance with an instruction which is input by a user of an external data terminal, and when the user inputs a selection instruction of a telephone ID in the second management table in response to the notification, executes outgoing processing from the telephone exchange apparatus to an external telephone terminal corresponding to the telephone ID.

4. The server apparatus according to claim 1, wherein
the controller notifies the second management table to a user of a telephone terminal in accordance with an instruction input by the user, and when the user inputs an instruction of the communication connection to select and specify an external data terminal to be associated with an external telephone terminal being in a call connection in response to the notification, executes a communication connection between a data terminal associated with a telephone ID of the telephone terminal and an external data terminal to be associated with a telephone ID of the external telephone terminal.

5. The server apparatus according to claim 1, wherein
the controller executes a communication of selected and specified application data among a plurality of items of application data differing from one another between data terminals and external data terminals to be made a communication connections with one another.
